(19) United States
(12) Patent Application Publication
(10) Pub. No.: US 2026/0152670 A1
(43) Pub. Date: Jun. 4, 2026

(54) CORROSION MITIGATION KIT

(71) Applicant: Able Industrial Products, Inc., Ontario, CA (US)

(72) Inventors: Jeffrey A Britton, Oceanside, CA (US); Gilbert J. Martinez, Hacienda Heights, CA (US)

(21) Appl. No.: 19/320,620

(22) Filed: Sep. 5, 2025

Related U.S. Application Data
(60) Provisional application No. 63/692,078, filed on Sep. 7, 2024.

(51) Int. Cl. C09J 5/00; B32B 37/08; B32B 37/10; C09J 7/40; C09J 9/00

(52) U.S. Cl. CPC C09J 5/00; B32B 37/08; B32B 37/10; C09J 7/405; C09J 9/00; B32B 2307/7376; B32B 2309/02; B32B 2309/04; B32B 2405/00

(57) ABSTRACT

A method of protecting an environmentally-exposed surface of a vehicle that includes a sheet of combined laminate that is over 900 cm². The combined laminate is formed by combining 3M 481 and a moisture stabilized or PET Release liner of sufficient thickness. The combined laminate is cut into a piece of a particular shape confirming to the portion of the exposed surface and subsequently applied. The shapes can be cut from the sheet in any suitable fashion, including for example die-cutting, using a wide format CNC or digital router, and using a waterjet cutting or laser.

This application claims priority to U.S. provisional application 63/692,078, filed Sep. 7, 2024. U.S. provisional application 63/692,078 and all other extrinsic references contained herein are incorporated by reference in their entirety.

### FIELD OF THE INVENTION

The field of the invention is protection of surfaces.

### BACKGROUND

The background description includes information that may be useful in understanding the present invention. It is not an admission that any of the information provided herein is prior art or relevant to the presently claimed invention, or that any publication specifically or implicitly referenced is prior art.

There is a need to protect environmentally exposed surfaces from corrosion and kinetic damage. This problem is relevant for the exposed surfaces of vehicle components including for example exposed surfaces of aircraft, tanks, ships, missile systems, unmanned drones and spacecraft. Long term storage, current usage, and wash cycles of these vehicle components cause corrosion on the exposed surfaces.

Non-adhesive tapes such as technologies using magnets do not provide adequate protection to the exposed surface as they fall off easily. In addition, other materials and adhesives have plasticizers and compounds like acetoxy silicones which release acetic acid on exposed surfaces when enclosing or covering exposed metallic surfaces thereby promoting the process of reduction, corrosion. The plasticizers that provide flexibility to vinyl tapes diffuse out of the tape and upon release cause contamination of the exposed surface and the low molecular weight compounds will migrate to nearby surfaces.

A possible solution for providing protection of exposed surfaces of vehicle components is the use of magnets or static electricity attraction, however using magnets presents its own challenges and static attraction can be diminished over time. The exposed surface of vehicle components needs to be ferromagnetic or at least paramagnetic (susceptible to magnetic attraction) for magnets to be deployed in a protective covering. It is thought that many of the environmentally exposed surfaces of military vehicle components, including for example aircraft and missile systems, comprise composite carbon fiber reinforced epoxy (CFRE) and low-observable/radar absorbing coatings, which can provide little to no attraction to magnets. Even if some of the exposed surfaces are susceptible to magnetic attraction, using magnets as part of a protective covering can pose several problems. Among other things, the strength of the magnet field can cause the magnets to indent or scratch the exposed surface of the vehicle component. Also, protective coverings coupled to a protected surface by weak magnetic fields or static cling can easily be displaced, thereby providing inadequate protection to the exposed surfaces. Storage of protective coverings that incorporate or are used with magnets can be problematic during storage and deployment.

Preservation sealing tape (such as 3M™ 481 adhesive tape) is conformable, provides a good barrier when overlapped, and has been deemed safe for direct application to the skin of the military aircraft surfaces without causing damage upon removal. However, such tape, available on narrow rolls, is time-consuming to apply. In addition, experience has shown that there is risk of damaging the surfaces to be protected when installers use blades to cut the tape. Application of narrow slit rolls poses a hazard to those that must apply it. Still further, alignment of the tape can be challenging since the tape backing is extensible and becomes distorted and difficult for alignment.

One could use large pieces of an adhesive-coated material instead of narrow adhesive rolls, but one of ordinary skill in the art would reject that idea as unworkable since large pieces have issues covering complex curved surfaces, and large pieces that are adhesive cannot be moved around to properly position on the surfaces.

Moreover, large rolls of preservation sealing tape - and in particular the 3M 481 tape - have been impractical to use because the tape distorts and curls easily while unrolling, creating challenges. Thus, there has not been a way to reliably unroll and apply large sheets of adhesive tape such that it could be used on surfaces such as those on an aircraft.

The following description includes information that may be useful in understanding the present invention. It is not an admission that any of the information provided herein is prior art or relevant to the presently claimed invention, or that any publication specifically or implicitly referenced is prior art.

In some embodiments, the numbers expressing quantities of ingredients, properties such as concentration, application conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

Thus, there is still a need for apparatus and methods for reliably unrolling and applying preservation sealing tape for use in protecting surfaces against corrosion and other environmentally caused damage.

### SUMMARY OF THE INVENTION

The inventive subject matter provides apparatus, systems and methods in which a section of preservation sealing tape is aligned with a corresponding section of polyester liner. A stiffener is applied to the leading edge of the aligned sections, which are then passed through a pair of rollers to create a combined laminate.

In embodiments, the adhesive side of the preservation sealing tape faces the polyester liner. The adhesive side is applied to the surfaces to be protected when the preservation sealing tape is separated from the polyester liner.

To further enhance the process of creating the combined laminate, the preservation sealing tape can be cooled prior to aligning the preservation sealing tape with the polyester liner. In embodiments, the preservation sealing tape is cooled in an environment of −40 F for a time period between 12-24 hours.

In embodiments of the inventive subject matter, a surface is protected using the following steps: securing an appropriate adhesive covering material such as the combined laminate having a thickness of 0.05 mm-0.09 mm, cutting the combined laminate into desired non-rectangular shapes having a top surface area of at least 900 cm², removing any backing layers (such as the polyester liner), and positioning the cut shapes of the preservation sealing tape onto a surface of a component. Larger pieces are contemplated with top surface area of at least 1,500 cm², at least 5,000 cm², and at least 5,000 cm^{2.} The largest practical sizes likely have a top surface area of at most 25,000 cm².

Contemplated components upon which the claimed methods can be used to prevent or minimize corrosion or other damage, include environmentally exposed surfaces of vehicles, defined herein to include exposed surfaces of aircraft, tanks, ships, missile systems, unmanned drones and spacecraft.

Preferred covering materials are sufficiently resistant to weather and other environmental stress to provide adequate protection again corrosion, are sufficiently flexible to confirm to the surface(s) being covered, and utilize an adhesive that provide sufficient holding strength, yet allow for removal without damaging the surface being protected, or leaving unacceptable amounts of adhesive on the surface. Covering materials of any suitable thickness can be used, however, preferred covering materials have a thickness of 0.06 mm±0.04 mm.

The most preferred material is preservation sealing tape in wide sheets, at least 6″ wide (approx 15.2 cm), more preferably at least 12″ wide (approx 30.4 cm), still more preferably at least 24″ wide (approx 60.8 cm), and most preferably at least 48″ wide (approx 121.92 cm). Where the surfaces to be covered involve military equipment or commercial aircraft, the covering material(s) should comply with military specification (Milspec) or other applicable specification standard. Examples of suitable preservation sealing tape include 3M™ 481, 425, 2364 or 231.

All suitable adhesives are contemplated, provided they provide sufficient holding without being so strong that removal damages the surface(s) being protected, and without leaving undue reside. Preferred adhesives are rubber-based or acrylic-based, which include modified rubber-based and modified acrylic-based that will not leave a residue or potential ghosting on the surface applied.

Shapes can be cut in any suitable fashion, including for example die-cutting, using a wide format CNC or digital router, and using a waterjet cutting or laser, or high-speed rotary die-cutting equipment.

### BRIEF DESCRIPTION OF THE DRAWING

FIG. 1 is a photograph showing the problems that arise from unrolling a large sheet of preservation rolling tape, prior to the systems and methods of the inventive subject matter.

FIG. 2 illustrates the problems arising from the process of rolling preservation sealing tape and an aligned polyester liner through rollers without a stiffener to attempt to create a combined laminate.

FIG. 3 is a flowchart of the process to produce the combined laminate.

FIG. 4 is an illustration of the process of rolling preservation sealing tape and an aligned polyester liner through rollers with a stiffener to create the combined laminate, according to embodiments of the inventive subject matter.

FIG. 5 illustrates the process of creating a combined laminate, including showing a section of created combined laminate after rolling.

FIG. 6 is a top view of a portion of a sheet of combined laminate depicting cut lines that delineate multiple shaped pieces, according to one example of the inventive subject matter.

FIG. 7 is a top view of a portion of a sheet of combined laminate depicting cut lines that delineate multiple shaped pieces, according to another example of the inventive subject matter.

FIG. 8 is a top view of a portion of sheet of combined laminate depicting cut lines that delineate multiple shaped pieces, according to a third example of the inventive subject matter.

FIG. 9 is a top view of a portion of sheet of combined laminate covering material depicting cut lines that delineate multiple shaped pieces, according to a fourth example of the inventive subject matter.

### DETAILED DESCRIPTION

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

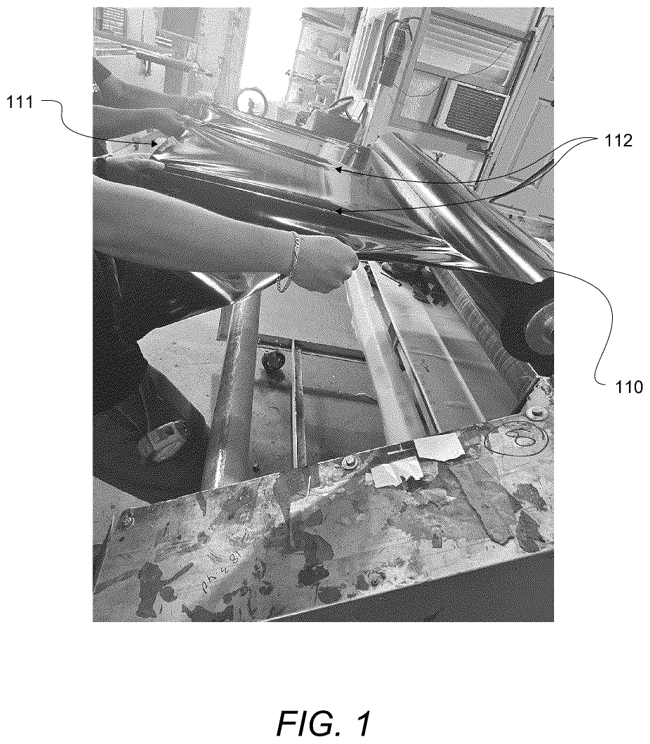

FIG. 1 is a photograph of the manual unrolling of a preservation sealing tape 110 having a large width from a source roll. As the sealing tape 110 is unrolled, there is visible curling/cupping 112 at the leading edge 111 of the preservation sealing tape 110. There is also extensive curling/cupping extending inward from the points where pressure or force has been applied by the personnel unrolling the tape.

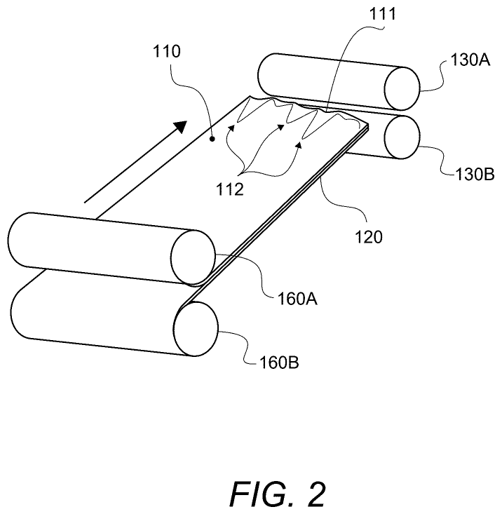

FIG. 2 is a diagrammatic overview of the process of rolling the preservation sealing tape 110 and a polyester liner 120 through rollers 130a, 130b without a stiffener to attempt to create a combined laminate. As seen in FIG. 2, the preservation sealing tape 110 is aligned with the liner 120 in order to introduce the tape 110 and liner 120 through the rollers 130a, 130b in the direction of the arrow. However, as was illustrated in FIG. 1, applying a pulling force to the preservation sealing tap 110 creates cupping, distortion, and/or curling 112 starting at the leading edge 111 and propagating rearwardly into the material. This processing and use renders the preservation sealing tape 110 unsuitable for the purposes of protecting large surfaces such as aircraft surfaces. Moreover, a curled, cupped or otherwise warped material cannot be reliably combined with a release liner.

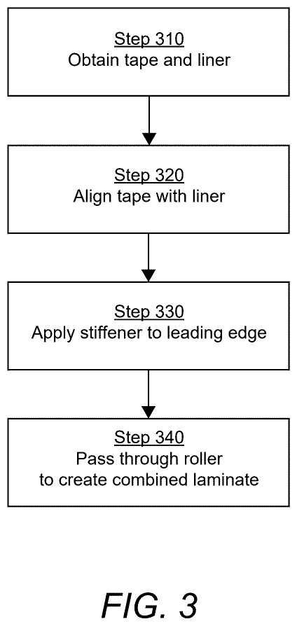

FIG. 3 is a flowchart of a process of generating a combined laminate, according to embodiments of the inventive subject matter.

At step 310, at least one section of preservation sealing tape 110 and at least one section of a polyester liner 120 are obtained. The sections of preservation sealing tape 110 and polyester liner 120 can be obtained from respective source rolls of the material.

In embodiments of the inventive subject matter, the preservation sealing tape 110 can be 3M™ 481 adhesive tape.

In embodiments of the inventive subject matter, the polyester liner has a thickness of approximately 5 millimeters (for example, 5 mm plus or minus 0.5 mm).

In embodiments of the inventive subject matter, the section of preservation sealing tape 110 is at least 48 inches wide.

In embodiments of the inventive subject matter, the preservation sealing tape 110 can be cooled before being deployed for this process (prior to step 320). In embodiments of the inventive subject matter, the preservation sealing tape is cooled in an environment of −40 F for a time period between 12-24 hours. Cooling the preservation sealing tape 110 in this manner slows down the visco-elastic properties of the adhesive and prevents stretching of the facestock preservation sealing tape 110 during the process.

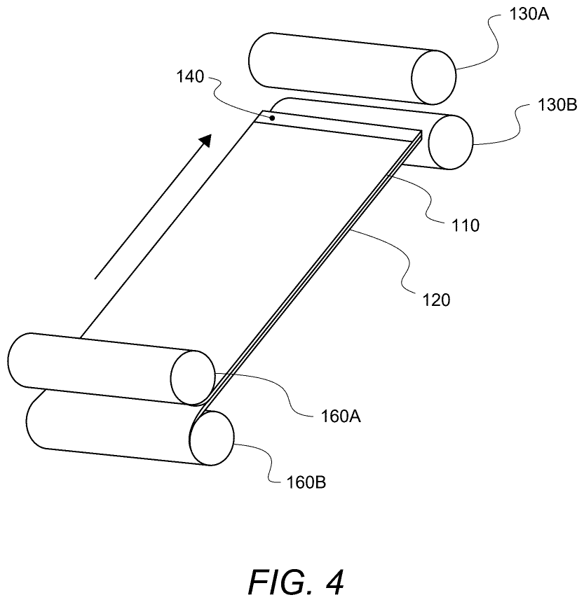

At step 320, the preservation sealing tape 110 and polyester liner are aligned for subsequent combination. This is shown in FIG. 4, where the preservation sealing tape 110 is aligned above the polyester liner 120. However, it is contemplated that the polyester liner 120 can be on top of the preservation sealing tape 110. In other situations, the rollers 130a, 130b can be vertically disposed. In these situations, the preservation sealing tape 110 and polyester liner 120 are correspondingly vertically aligned as well.

As discussed herein, alignment is intended to refer to the entirety of the section of sealing tape 110 having a corresponding section of polyester liner 120. This means that, in certain situations, the section of polyester liner 120 could be larger (for example, wider) than the sealing tape 110.

In embodiments of the inventive subject matter, the preservation sealing tape 110 has an adhesive on a first side, that faces the polyester liner 120 when the preservation sealing tape 110 and the polyester liner 120 are aligned. This enables the adhesion of the preservation sealing tape 110 to the polyester liner 120 and also protect the adhesive side from the environment until preservation sealing tape 110 is to be applied to a surface.

In the illustrations shown herein, the preservation sealing tape 110 is observed as being on top of the polyester liner 120. However, in embodiments, the preservation sealing tape 110 can be beneath the polyester liner 120. This way, the process can be more easily observed for creases forming during the lamination process.

At step 330, a stiffener 140 is applied to the leading edge of the aligned sections of the preservation sealing tape and the polyester liner.

As seen in FIG. 4, the preservation sealing tape 110 is aligned with the liner 120, and the stiffener 140 has been applied prior to passing through the rollers 130a, 130b.

The stiffener 140 can be made of any suitable, sufficiently stiff material. In this instance, sufficiently stiff is intended to refer to being stiff enough such that the stiffener 140 does not bend or deform under the forces exerted by personnel or the preservation sealing tape itself (such as the curling or cupping forces) during the process, and also by the rollers 130a, 130b as the preservation sealing tape passes through. Examples of suitable materials can include metals, hard rubbers, hard plastics, and wood.

Polyester liner 120 is used because other materials did not properly support preservation sealing tape 110 without creasing or other undesirable effects. As noted elsewhere, in preferred embodiments, the thickness of the polyester liner is 5 mm. Results of testing showed that thicknesses of 3 mm or 4 mm did not work properly.

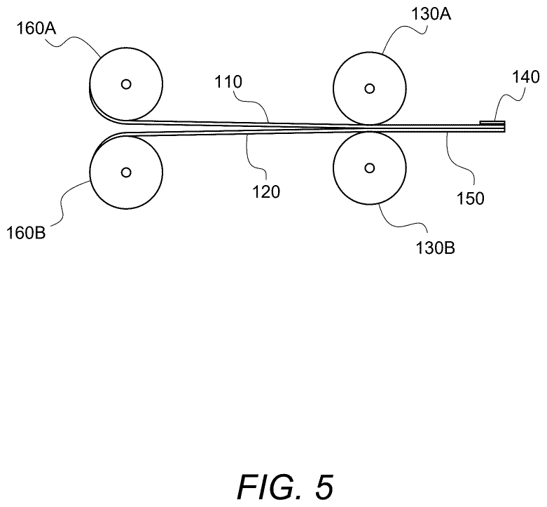

At step 340, the preservation sealing tape 110 and aligned polyester liner 120, with the stiffener 140, are passed through the rollers 130a, 130b to create a combined laminate 150. This is illustrated in FIG. 5. The process illustrated in FIG. 5 minimizes waste in producing the combined laminate 150.

In embodiments of the inventive subject matter, a pressure is applied the preservation sealing tape 110, the polyester liner 120, or both sides, prior to and during the process of passing through the rollers 130 a, 130 b. The total optimal pressure applied is between 10-15 psi, which insures optimal lamination. Pressures above that range begin to negatively affect the combination, and unwanted stretching of the materials can occur.

In embodiments of the inventive subject matter, the combined laminate 150 can be rolled onto a roll for subsequent storage, transportation, deployment, and/or further processing on demand.

The combined laminate 150 can then be deployed and used as discussed below to protect surfaces such as the surfaces or sections of an aircraft, space craft or other vehicle, to minimize the process of reduction (corrosion).

In order to be deployed, the combined laminate 150 can be cut into predetermined shapes. The predetermined shapes can correspond to sections of a vehicle, such as an aircraft, that require protection against water, chemicals and/or particulate.

The combined laminate 150 can be deployed by first separating the preservation sealing tape 110 from the polyester liner 120 and then applying the preservation sealing tape 110 to the desired surface.

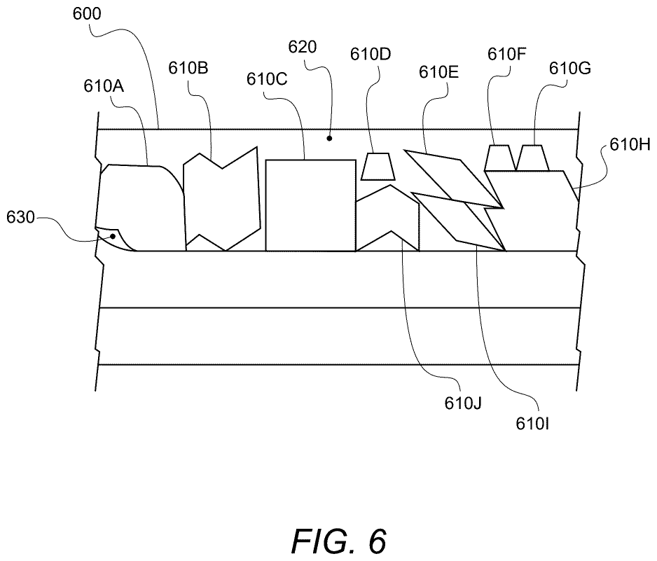

FIG. 6 is a top view of a portion of a sheet 600 of combined laminate 150 depicting cut lines that delineate multiple shaped pieces 610A-610J. Piece 610A is shown as partially peeled off to reveal the backing polyester liner 120. Sheet 600 has unused space 602. In this preferred example, the portion of sheet 600 shown in FIG. 6 has dimensions of 48″ (approx 128.9 cm) by 92″ (approx 233.7 cm). Pieces 610A-610L can be cut using any of die-cutting, wide format CNC or digital router, and a waterjet cutting or laser stamping (die cutting) machine.

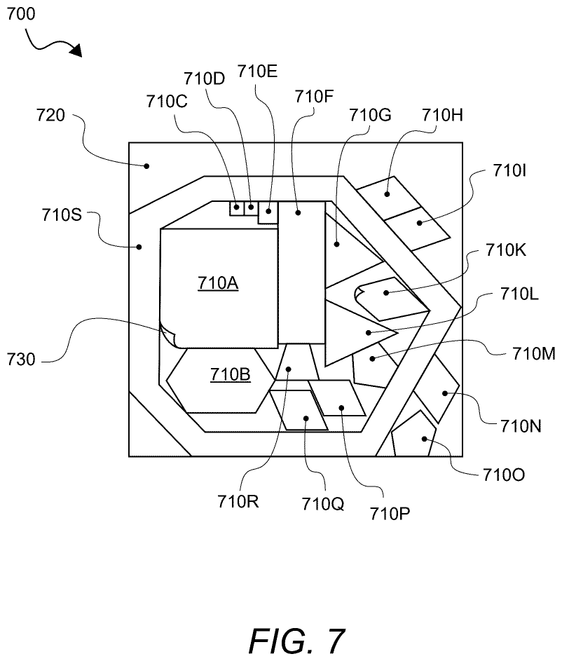

FIG. 7 is a top view of a portion of a sheet 700 of combined laminate 150 depicting cut lines that delineate multiple shaped pieces 710A-710S. Piece 710A is shown as partially peeled off to reveal the backing polyester liner 120. Sheet 700 has unused space 702. In this preferred example, the portion of sheet 700 shown in FIG. 7 has dimensions of 48″ (approx 128.9 cm) by 52″ (approx 132.1). Pieces 710A-710S can be cut using any of die-cutting, wide format CNC or digital router, and a waterjet cutting or laser stamping (die cutting) machine.

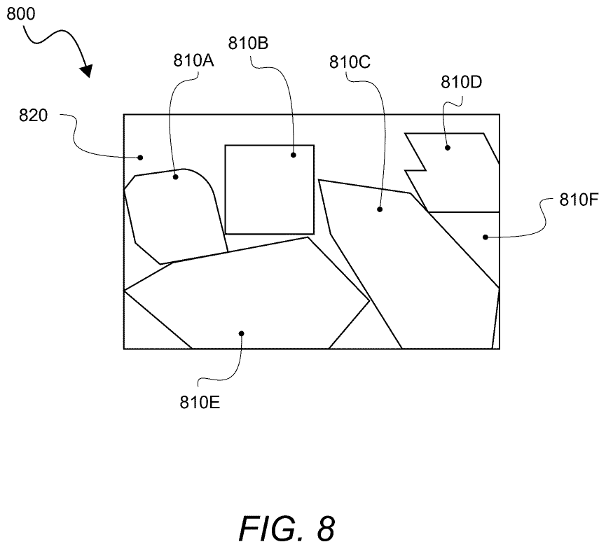

FIG. 8 is a top view of a portion of sheet 800 of combined laminate 150 depicting cut lines that delineate multiple shaped pieces 810A-810F. Sheet 800 has unused space 802. In this preferred example, the portion of sheet 800 shown in FIG. 8 has dimensions of 48″ (approx 128.9 cm) by 76″ (approx 193.1 cm). Pieces 810A-810F can be cut using any of die-cutting, wide format CNC or digital router, and a waterjet cutting or laser stamping (die cutting) machine.

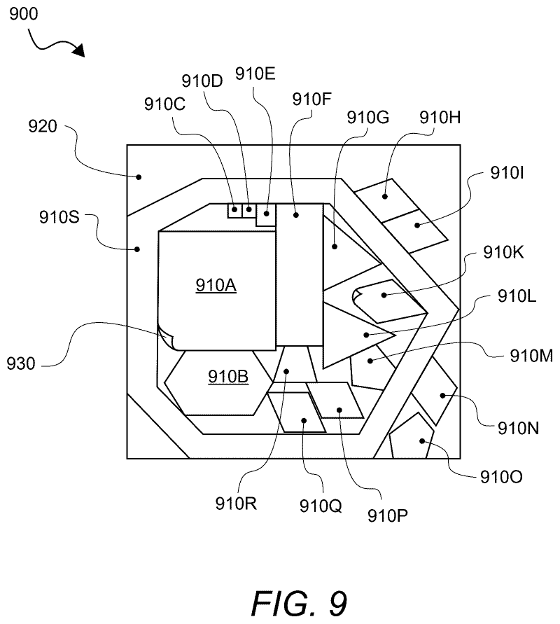

FIG. 9 is a top view of a portion of sheet 900 of multilayer covering multilayer covering material depicting cut lines that delineate multiple shaped pieces 910A-910S. Piece 910A is shown as partially peeled off to reveal the backing polyester liner 120. Sheet 900 has unused space 902. In this preferred example, the portion of sheet 900 shown in FIG. 9 has dimensions of 48″ (approx. 128.9 cm) by 56″ (approx. 142.24 cm). Pieces 910A-910S can be cut using any of die-cutting, wide format CNC or digital router, and a waterjet cutting or laser stamping (die cutting) machine.

As noted above, it is contemplated that each of sheets 600, 700, 800, and 900 of combined laminate 150 can be supplied in a roll format.

In embodiments of the inventive subject matter, one or more of the shaped pieces illustrated in FIGS. 6-9 can be shaped to cover a specific section of a vehicle such as an aircraft.

In embodiments of the inventive subject matter, the pieces discussed in one or more of FIGS. 6-9 that are meant to be applied next to each other can have tapered edges. A first piece can have a tapered edge and a second piece meant to be applied next to the first piece can have an oppositely-tapered edge, such that the tapered edge of the first piece and the tapered edge of the second piece match. In this way, there are no abrupt edges that potentially leave parts of the underlying surfaces exposed.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method for generating a corrosion mitigation kit, comprising:
obtaining a section of preservation sealing tape;
obtaining a section of polyester liner;
aligning the preservation sealing tape and the polyester liner;
applying a stiffener to the leading edge of the aligned sections of preservation sealing tape and polyester liner; and
passing the aligned sections of preservation sealing tape and polyester liner with the applied stiffener through a pair of rollers to create a combined laminate.

2. The method of claim 1, wherein the preservation sealing tape has an adhesive on a first side that faces the polyester liner when the preservation sealing tape and polyester liner are aligned.

3. The method of claim 1, further comprising: after the obtaining sections of preservation sealing tape and polyester liner and prior to the step of aligning, cooling the preservation sealing tape.

4. The method of claim 3, wherein the step of cooling the preservation sealing tape comprises cooling the preservation sealing tape in an environment of −40 F for a time period between 12-24 hours.

5. The method of claim 1, wherein the preservation sealing tape comprises preservation sealing tape 481.

6. The method of claim 1, wherein the polyester liner has a thickness of 5 mm plus or minus 0.5 mm.

7. The method of claim 1, wherein the section of preservation sealing tape is at least 48 inches wide.

8. The method of claim 1, further comprising cutting the combined laminate into predefined shapes.

9. The method of claim 8, wherein the predefined shapes correspond to sections of an aircraft.

10. The method of claim 9, further comprising:
separating the preservation sealing tape from the polyester liner; and
applying the preservation sealing tape to a surface.
